(19) United States
(12) Patent Application Publication
(10) Pub. No.: US 2014/0083888 A1
(43) Pub. Date: Mar. 27, 2014

(54) Extension Ladder Tool Caddie

(71) Applicant: Dale Constable, Fenton, MI (US)

(72) Inventor: Dale Constable, Fenton, MI (US)

(21) Appl. No.: 14/035,196

(22) Filed: Sep. 24, 2013

Related U.S. Application Data
(60) Provisional application No. 61/705,681, filed on Sep. 26, 2012.

(51) Int. Cl. E06C 7/14

(52) U.S. Cl. CPC E06C 7/14
USPC 206/372; 206/349

(57) ABSTRACT

An extension ladder tool caddie is provided that comprises an elongated bridge portion having a first and second end receptacle portion adapted to receive the upper rail ends of an extension ladder fly therein. The caddie is supported by the upper rail ends and is positioned therebetween to form an upper ladder rung that supports tools for a worker along the ladder. The bridge portion of the device includes an open upper having a plurality of defined cavities for supporting different hand tools, appliances, and fasteners therein for stable containment thereof and ready access thereto. A first and second tab is further provided along the exterior sidewall of the bridge portion for supporting suspended tools such as paint brushes and screw driver tools. The assembly is specifically suited for extension ladders and provides a tool caddie at the upper, open portion of the extension ladder fly.

### CROSS REFERENCE TO RELATED APPLICATION

This application claims the benefit of U.S. Provisional Application No. 61/705,681 filed on Sep. 26, 2012, entitled “The DRC Ladder Buddy.” The above identified patent application is herein incorporated by reference in its entirety to provide continuity of disclosure.

### BACKGROUND OF THE INVENTION

1. Field of the Invention

The present invention relates to tool supports for ladders. More specifically, the present invention pertains to a new tool caddie that is adapted to be supported across the upper end of an extension ladder fly for supporting tools and articles therein for easy user access.

Working on a ladder requires still and practice, as the user has to engage in work activities while balancing himself on the ladder to prevent falling and to prevent dropping tools. In order to maintain a safe working environment, the user will generally carry tools on a work belt or place them on an open ledge of the roof or building being worked upon. For stepladders, the user can simply support tools and paint buckets from the upper surface of the ladder or from a support surface extending from the opposing side of the ladder. However, when using an extension ladder the user's ability to support tools thereon is eliminated and the act of supporting tools becomes more difficult.

Extension ladders are compound ladder assemblies that are not self-supporting. These ladders include a lower ladder base section comprised of opposing rails and a plurality of ladder rungs. Extendable from the base section is a fly section that is similarly structured but able to slide in a parallel relationship with the base section and lock into place thereagainst to extend the overall length of the ladder. This allows a user to store a shorter ladder assembly and operably extend the same when accessing higher work spaces, including roof surfaces and surfaces that can support the ladder thereagainst.

The extension ladder bears against the work space and includes an open upper portion comprised of the upper extent of each fly section rails. Since the upper portion of the fly section does not include its own dedicated surface or rung, it is not possible to support a tool caddy therefrom that is otherwise meant for use in conjunction with the upper step of a stepladder. The present invention is therefore disclosed as a new and novel tool caddy that is particularly adapted for use in conjunction with the upper extent of each rail of an extension ladder fly section.

The present invention comprises an extension ladder tool caddie that is designed to function in connection with the upper terminations of the extension ladder fly rails. The device secures to the first and second fly rail termination by way of a first and second end receptacle, which accepts the rail ends therein. Between the receptacles is an elongated bridge member having an open upper adapted to receive various tools and supplies typically utilized in home construction, home repair, and painting activities. The open upper is segmented into a plurality of cavities that support these articles, while one end of the device includes a first and second tab adapted to support exterior articles therethrough.

2. Description of the Prior Art

Devices have been disclosed in the prior art that relate to tool caddies and those suited for use in conjunction with a ladder. These include devices that have been patented and published in patent application publications. These devices generally mostly relate to those suited for stepladders and other ladder types. The following is a list of devices deemed most relevant to the present disclosure, which are herein described for the purposes of highlighting and differentiating the unique aspects of the present invention, and further highlighting the drawbacks existing in the prior art.

One such device in the prior art is U.S. Pat. No. 5,603,405 to Smith, which discloses a ladder top storage rack having a rigid tool box with a hinged lid, a plurality of zippered side pouches and an underside strap that secures the tool box to the flat upper portion of a ladder. Longitudinal and lateral straps are utilized as the connection means between the tool box and the ladder, whereby the user has access to the tool box interior when at the top of the ladder. While discloses a useful tool box for a ladder, the Smith device is more suited for use with a folding stepladder, as opposed to the open upper configuration of an extension ladder. Extension ladders comprise an extendable fly having an open upper and terminating with a first and second rail cap, as opposed to stepladders that provide an upper top cap platform to rest tools and support a standing user thereon.

Another device is U.S. Pat. No. 4,874,147 to Ory, which discloses a utility tray adapted for use with stepladders, wherein a pivoting lid is provided over an upper mounting plate attached to the upper step of a stepladder. The tray include compartments for retention of worker tools and other articles therein, while the device further provides an attachment for caster wheels for use independent from a stepladder. While relating to a ladder tool caddy, the Ory device fails to contemplate a device suitable for use with an extension ladder, and is more related to a general purpose utility tray that is adaptable for use with a stepladder.

U.S. Pat. No. 5,950,972 to Irish discloses a ladder mounted container similar to both the Smith and Ory devices, wherein a container apparatus includes a lower skirt extending from the lower surface of the container and attachment straps for securing the skirt to the upper portion of a ladder. The Irish device is suited for use in conjunction with A-frame stepladders only, wherein the Irish straps would otherwise be non-functional if deployed on an extension ladder assembly.

U.S. Pat. No. 5,901,998 to Gallo, Jr. discloses a ladder-top tool carrier having an underside recess, a lifting handle, and at least one strap to secure the carrier to the upper portion of a stepladder. Several openings through the carrier provide for tool support, while the upper surface provides a tray to loosely support articles thereon. Similar to the aforementioned devices, the Gallo, Jr. devices fails to contemplate an assembly suitable for use with extension ladder uppers.

Finally, U.S. Pat. No. 5,941,344 to Spadaro discloses a caddy tray having an underside designed to fit over the top side of a step-ladder, wherein adjustable straps provide for secure fitment. An elongated tray extends from the area of connection on the caddy, while the caddy itself includes depressions and side pockets to support tools and supplies. Similar to the Gallo, Jr. and the other prior art devices, the Spadaro device is suited for stepladders and not for extension ladder caddies.

The prior art devices all consider a tool caddie that is adapted for use with a ladder. However, no devices are disclosed in the art that relate to a tool caddie spanning the upper rails of an extension ladder fly section, wherein the caddie includes a plurality of tool supports therefrom and a first and second end receptacle to accept the upper extent of each fly rail therein.

It is submitted that the present invention is substantially divergent in design elements from the prior art, and consequently it is clear that there is a need in the art for an improvement to existing ladder tool caddie devices. In this regard the instant invention substantially fulfills these needs.

### SUMMARY OF THE INVENTION

In view of the foregoing disadvantages inherent in the known types of ladder tool caddies and tool supports now present in the prior art, the present invention provides a new tool caddie that can be utilized for providing convenience for the user when supporting articles at the upper extent of an extension ladder.

It is therefore an object of the present invention to provide a new and improved extension ladder tool caddie device that has all of the advantages of the prior art and none of the disadvantages.

It is another object of the present invention to provide an extension ladder tool caddie device that is adapted to receive the upper rails of an extension ladder fly section therein and position therebetween for tool and article support for the user.

Another object of the present invention is to provide an extension ladder tool caddie device that includes a bridge portion between two opposing ladder rail receptacles, wherein the bridge portion includes a plurality of tool support apertures therein.

Yet another object of the present invention is to provide an extension ladder tool caddie device that includes several apertures and tool supports that are capable of supporting tools of different tasks related to ladders, including those of painting tools, fastening tools, and other tool and article types deemed necessary by the user.

Another object of the present invention is to provide an extension ladder tool caddie device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a view of an embodiment to the present invention supported along the upper extent of an extension ladder fly section.

FIG. 2 shows another view of an embodiment to the present invention supported along the upper extent of an extension ladder fly section.

FIG. 3 shows a perspective view of an embodiment of the present invention.

FIG. 4 shows an underside view of an embodiment of the present invention.

### DETAILED DESCRIPTION OF THE INVENTION

Reference is made herein to the attached drawings. Like reference numerals are used throughout the drawings to depict like or similar elements of the extension ladder tool caddie device. For the purposes of presenting a brief and clear description of the present invention, the preferred embodiment will be discussed as used for supporting tools and other articles from the upper extent of an extension ladder fly. The figures are intended for representative purposes only and should not be considered to be limiting in any respect.

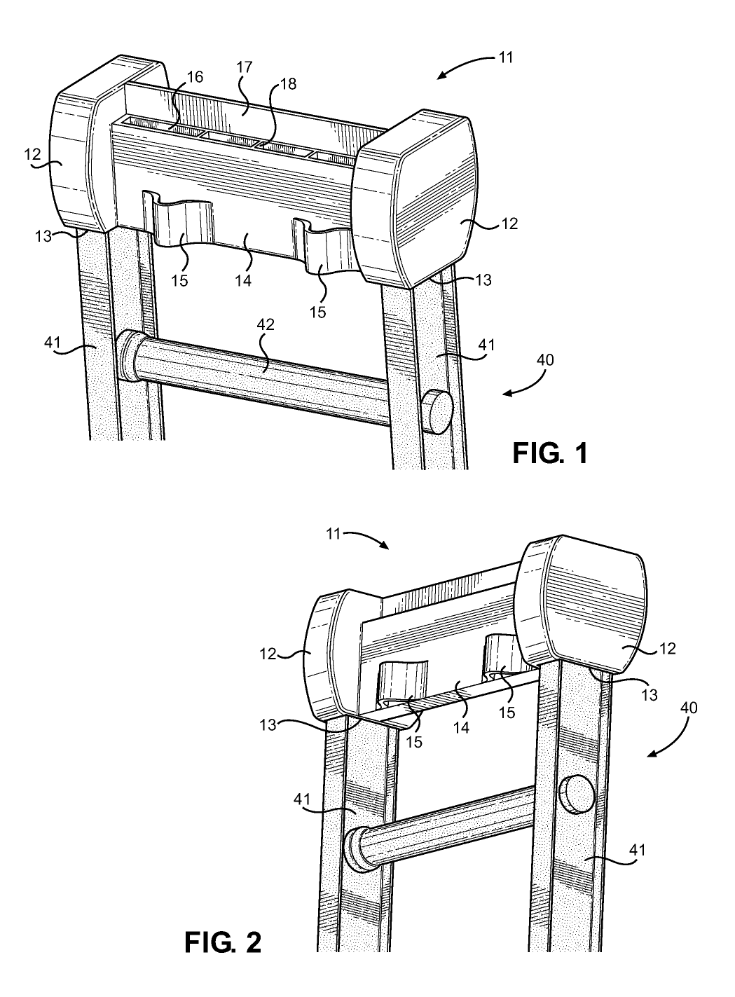

Referring now to FIGS. 1 and 2, there are shown two perspective views of the tool caddie of the present invention in a working state, applied to the upper extent of an extension ladder for the purposes of tool support for a user thereon. The tool caddie 11 comprises an elongated construction having a first and second end. the first and second end comprise ladder rail receptacles 12 having an open lower portion 13 and a hollow interior adapted to receive the upper extent of each side rail 41 of the extension ladder fly 40. Between the first and second ladder rail receptacle 12 is an elongated bridge portion 14 that spans therebetween in a similar fashion as a ladder rung 42.

The bridge portion 14 comprises an open upper 16 that is adapted to receive various tools, articles, and fasteners therein for storage prior to use. The open upper may be segmented into smaller sections by dividers 18, whereby the dividers separate the open upper into smaller cavities to receive tools therein. The body of the bridge portion 14 is open such that tools can be received through the open upper 16 and supported within the interior of the bridge portion 14 while in use.

Finally, along the tool caddie bridge portion there are disposed several external tool support that are adapted to receive and support handled tools therein. The tool supports comprise tabs 15 forming a closed loop against the bridge portion outer surface, whereby a hand tool can be supported therethrough and suspended prior to use. Contemplated uses include support of paint brushes, screw drivers, and other hand tools that can be fitted through the closed loop tabs 15 and be supported thereby in a suspended configuration against the outside of the bridge portion 14.

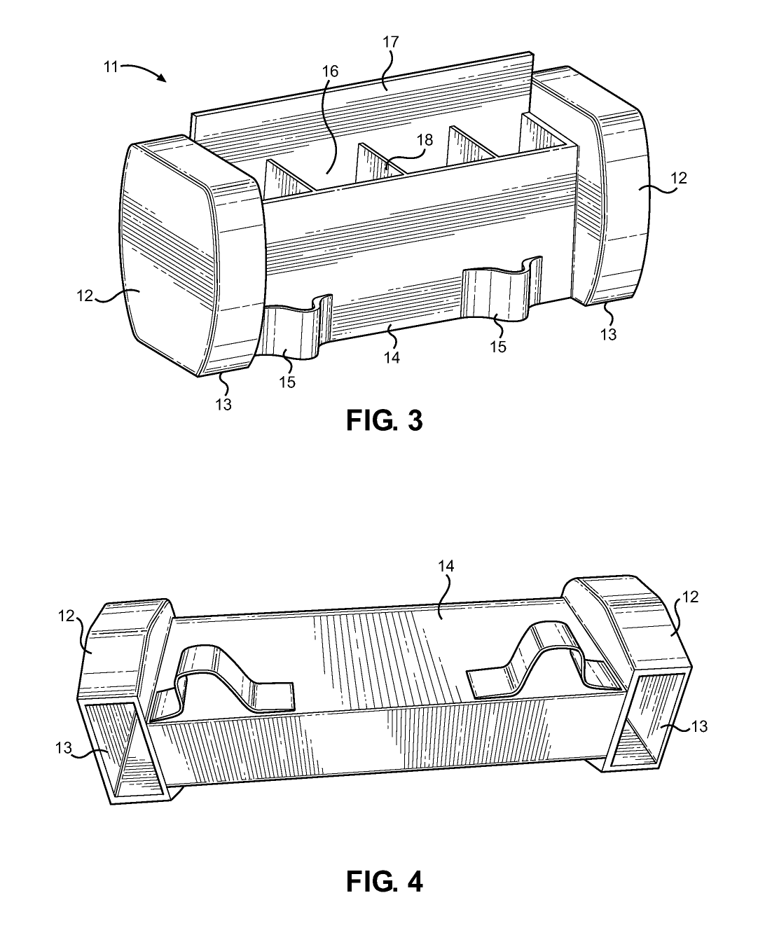

Referring now to FIGS. 1 and 3, there are shown two embodiments of the open upper 16 of the bridge portion 14, whereby the size and arrangement of the dividers 18 is differently defined for support of different sized articles. Both embodiments contemplate a backsplash 17, which comprises an upstanding surface adapted to allow tools and fasteners to bear thereagainst and counteract the tools from falling out of the bridge portion apertures while the ladder is being situated. The backsplash 17 extends from one side of the open upper 16 and extends above the open upper of the bridge portion 14.

Referring now to FIG. 4, there is shown an underside perspective view of the tool caddie 11 of the present invention. This view illustrates the open receptacles 12 at the ends of the caddie. The receptacles 12 include an open lower 13 and an open interior that is adapted to receive the upper ends of an extension ladder rail therein. Once secured thereover, the bridge portion 14 is situated between the upper rails and can accept tools therein. The user positions the caddie on the ladder prior to, or after extending the extension fly, whereafter tools and other articles are supported while the user focuses on the given task and his or her own balance on the ladder.

Without a dedicated storage space on the top of an extension ladder, every time a user needs to use a new tool he or she needs to climb down the ladder, grab the tool, and climb back up with tool in hand. The more trips up and down a ladder, the more risk for injury. An innovative solution is needed to reduce the amount of trips and risk involved. The present invention describes a tool caddie specifically suited for extension ladders. The device attaches to the upper extent of a conventional extension ladder and includes multiple apertures for storing of tools and other supplies. The caddie can hold items such as nails, screws, or other materials needed while working at the top of the ladder. The device eliminates frequent trips up and down a ladder in order to retrieve various items that may be required to complete a job. This, in turn can reduce the risk of injuries and inefficiencies during painting and home repair activities.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A tool caddie for an extension ladder, comprising:
an elongated bridge portion having a first and second end;
said first and second end further comprising a first and second ladder rail receptacle;
each ladder rail receptacle having an open lower portion and a hollow interior adapted to receive the upper extent of an extension ladder side rail;
said elongated bridge having an open upper adapted to receive tools therein;
said bridge portion adapted to be positioned between two extension ladder side rails at the upper extent of an extension ladder.

2. The tool caddie of claim 1, wherein:
said open upper of said bridge portion being divided into segments by at least one divider.

3. The tool caddie of claim 1, wherein:
said open upper of said bridge portion further comprises an upstanding backsplash extending upwards therefrom.

4. The tool caddie of claim 1, wherein:
said elongated bridge portion further comprises an exterior surface having at least one tool support tab thereon, said tool support tabs having a closed loop configuration.
